(19) United States
(12) Patent Application Publication
(10) Pub. No.: US 2019/0373051 A1
(43) Pub. Date: Dec. 5, 2019

(54) Task Scheduling System for Internet of Things (IoT) Devices

(71) Applicant: International Business Machines Corporation, Armonk, NY (US)

(72) Inventors: Alecio Pedro Delazari Binotto, Sao Paulo (BR); Vagner Figueredo de Santana, Sao Paulo (BR)

(21) Appl. No.: 16/000,152

(22) Filed: Jun. 5, 2018

(51) Int. Cl. H04L 29/08; G06F 9/50

(52) U.S. Cl. CPC H04L 67/1008; H04L 67/306; H04L 67/12; G06F 2209/503; G06F 9/5044; H04L 67/22; H04L 67/303

(57) ABSTRACT

A method, apparatus, computer system, and computer program product for managing processing of tasks by network devices. A computer system receives a task to process for a user. The computer system identifies a group of the network devices in the computer system assigned to the user for processing the task based on capabilities of the group of the network devices and a task history of task processing by the group of the network devices. The computer system schedules a performance of the task by a selected network device in the group of the network devices. The task is performed by the selected network device in the computer system such that the tasks are processed by sharing workloads among the network devices.

### BACKGROUND

### 1. Field

The present disclosure relates generally to an improved computer system and, more specifically, to a method, an apparatus, a computer system, and a computer program product for scheduling tasks to be performed by network devices in a network data processing system.

### 2. Description of the Related Art

Increasingly, many different types of devices are capable of processing data and connecting to a network such as the Internet. Devices may include, for example, an automobile, a refrigerator, a thermostat, a temperature gauge, or other types of devices that include an ability to process data and connect to the Internet. These devices may be embedded with sensors, software, network connectivity, and other processing components that enable these devices to collect and exchange data. These devices are Internet of Things (IoT) devices.

With increasing diversity in the types of devices capable of processing data, these devices can provide specialized capabilities for use in specific situations. Depending on the demand for different types of capabilities, some devices may be impacted with respect to the quality of service offered to users of these environments.

For example, some devices, such as a mobile phone, have sensors that provide image generating capabilities. However, image processing tasks that may be requested, with respect to images, may reduce the quality of service provided when those tasks are performed by a mobile phone with a concurrent performance of other tasks. Further, the mobile phone may not include a dedicated graphics processing unit for image processing. In other words, the mobile phone may not have suitable image processing capabilities to provide a desired quality of service. In addition, the mobile phone may not have a network connection to the Internet that provides the desired speed for transmitting images or video.

Therefore, it would be desirable to have a method, an apparatus, a computer system, and a computer program product that take into account at least some of the issues discussed above, as well as other possible issues. For example, it would be desirable to have a method and apparatus that overcome a technical problem with processing tasks with a network device that may have limited capability with respect to the tasks assigned to the network device.

### SUMMARY

According to one embodiment of the present invention, a method for managing processing of tasks by network devices includes receiving, by a computer system, a task to process for a user. The computer system identifies a group of the network devices in the computer system assigned to the user for processing the task based on capabilities of the group of the network devices and a task history of task processing by the group of the network devices. The computer system schedules a performance of the task by a selected network device in the group of the network devices. The task is performed by the selected network device in the computer system such that the tasks are processed by sharing workloads among the network devices.

According to another embodiment of the present invention, a task processing system comprises a computer system and scheduler running on the computer system. The scheduler receives a task to process for a user and identifies a group of network devices in the computer system assigned to the user for processing the task based on capabilities of the group of the network devices and a task history of task processing by the group of the network devices. The scheduler schedules a performance of the task by a selected network device in the group of the network devices. The task is performed by the selected network device in computer system such that the tasks are processed by sharing workloads among the network devices.

According to yet another embodiment of the present invention, a computer program product for managing the processing of tasks comprises a computer-readable-storage media and first program code, second program code, and third program code stored on the computer-readable storage media. The first program code runs to receive a task to process for a user. The second program code runs to identify a group of the network devices in the computer system assigned to the user for processing the task based on capabilities of the group of the network devices and a task history of task processing by the group of the network devices. The third program code runs to schedule a performance of the task by a selected network device in the group of the network devices. The task is performed by the selected network device in the computer system such that the tasks are processed by sharing workloads among the network devices.

### BRIEF DESCRIPTION OF THE DRAWINGS

FIG. 1 is a pictorial representation of a network of data processing systems in which illustrative embodiments may be implemented;

FIG. 2 is a block diagram of a task environment in accordance with an illustrative embodiment;

FIG. 3 is an illustration of network device identification in accordance with an illustrative embodiment;

FIG. 4 is a block diagram illustrating managing resources using tokens in accordance with an illustrative embodiment;

FIG. 5 is a flowchart of a process for managing processing of tasks in accordance with an illustrative embodiment;

FIG. 6 is a flowchart of a process for identifying an availability of network devices in accordance with an illustrative embodiment;

FIG. 7 is a flowchart of a process for scheduling a task in accordance with an illustrative embodiment;

FIG. 8 is a flowchart of a process for processing a request to perform a task in accordance with an illustrative embodiment;

FIG. 9 is a flowchart of a process for indicating an availability in accordance with an illustrative embodiment; and

FIG. 10 is a block diagram of a data processing system in accordance with an illustrative embodiment.

### DETAILED DESCRIPTION

The present invention may be a system, a method, and/or a computer program product. The computer program product may include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random-access memory (RAM), a read-only memory (ROM), an erasable programmable read-only memory (EPROM or Flash memory), a static random-access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer-readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present invention.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, a special purpose computer, or other programmable data processing apparatus to produce a machine, such that the instructions, which execute via the processor of the computer or other programmable data processing apparatus, create means for implementing the functions/acts specified in the flowchart illustrations and/or block diagram block or blocks. These computer-readable program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart illustrations and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart illustrations and/or block diagram block or blocks.

The flowchart illustrations and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

The illustrative embodiments recognize and take into account one or more considerations. For example, the illustrative embodiments recognize and take into account that users increasingly utilize more processing power and other data processing resources. The illustrative embodiments also recognize and take into account that network devices, such as Internet of Things (IoT) devices, are present in more environments. The illustrative embodiments also recognize and take into account that network devices are heterogeneous in processing capabilities. In other words, different network devices may have different capabilities or combinations of capabilities. For example, one network device may have a camera while another network device may have a graphics processor. The camera provides sensor capabilities that generate images, video, or some combination thereof.

The illustrative embodiments recognize and take into account that with the connectivity of network devices and the heterogeneous capabilities in the network devices, the performance of tasks may be managed in a manner which distributes workloads through the network devices to increase efficiency in which tasks are performed. The illustrative embodiments recognize and take into account that tasks may be assigned to network devices based on the capabilities of those network devices.

Thus, the illustrative embodiments provide a method, an apparatus, a computer system, and a computer program product for managing the processing of tasks. In one illustrative example, a method for managing the processing of tasks by network devices includes receiving, by a computer system, a task to process for a user. The computer system identifies a group of the network devices in the computer system assigned to the user for processing the task based on capabilities of the group of the network devices and a task history of task processing by the group of the network devices. The computer system schedules a performance of the task by a selected network device in the group of the network devices. The task is performed by the selected network device in the computer system such that the tasks are processed by sharing workloads among the network devices.

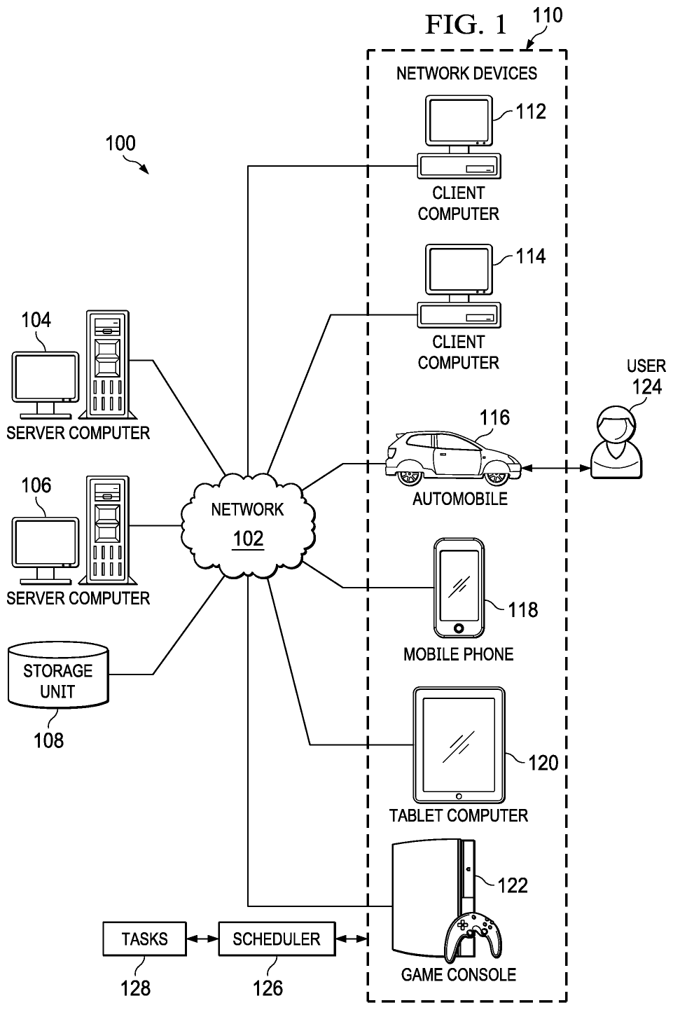

With reference now to the figures and, in particular, with reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections such as wire, wireless communication links, or fiber optic cables.

In the depicted example, server computer 104 and server computer 106 connect to network 102 along with storage unit 108. In addition, network devices 110 connect to network 102. As depicted, network devices 110 include client computer 112 and client computer 114. Network devices 110 may be, for example, computers, workstations, or network computers. In the depicted example, server computer 104 provides information, such as boot files, operating system images, and applications to network devices 110.

Further, network devices 110 can also include other types of network devices such as automobile 116, mobile phone 118, tablet computer 120, and game console 122. In this illustrative example, server computer 104, server computer 106, storage unit 108, and network devices 110 are connect to network 102 in which network 102 is the communications media for these network devices. Some or all of network devices 110 may form an Internet of Things (IoT) in which these physical devices can connect to network 102 and exchange information with each other over network 102.

Network devices 110 may be clients to server computer 104 in this example. Network data processing system 100 may include additional server computers, client computers, and other devices not shown. Network devices 110 connect to network 102 utilizing at least one of wired, optical fiber, or wireless connections.

Program code located in network data processing system 100 may be stored on a computer recordable storage medium and downloaded to a data processing system or other device for use. For example, program code may be stored on a computer recordable storage medium on server computer 104 and downloaded to network devices 110 over network 102 for use on network devices 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 may be comprised of at least one of the Internet, an intranet, a local area network (LAN), a metropolitan area network (MAN), or a wide area network (WAN). FIG. 1 is intended as an example and not as an architectural limitation for the different illustrative embodiments.

As used herein, “a number of,” when used with reference items, means one or more items. For example, “a number of different types of networks” is one or more different types of networks.

Further, the phrase “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item C. This example also may include item A, item B, and item C or item B and item C. Of course, any combinations of these items may be present. In some illustrative examples, “at least one of” may be, for example, without limitation, two of item A; one of item B; ten of item C; four of item B and seven of item C; or other suitable combinations.

In this illustrative example, user 124 is associated with network devices 110. User 124 may use different network devices at different times and for different purposes. For example, user 124 operates automobile 116 when traveling to and from work and other destinations. Further, user 124 carries mobile phone 118. User 124 operates client computer 112 at a work office and operates client computer 114, tablet computer 120, and game console 122 at home.

In this illustrative example, network devices 110 are heterogeneous with respect to the capabilities that network devices 110 provide. For example, mobile phone 118 provides image generation and location capabilities in addition to data processing. Automobile 116 provides temperature and rain sensors in addition to data processing capabilities. Game console 122 provides image processing, video processing, and audio processing capabilities. Tablet computer 120 provides image generation and location capabilities in addition to data processing capabilities. Network devices 110 also provide communications capabilities through their connections to network 102. The bandwidth for communications vary for the different network devices.

As depicted, scheduler 126 manages the performance of tasks 128 by network devices 110. For example, scheduler 126 operates to schedule the performance of tasks 128 by network devices 110. Scheduler 126 distributes tasks 128 in a manner that optimizes the manner in which tasks 128 are performed based on the capabilities of network devices 110. Scheduler 126 takes into account capabilities of network devices 110 as well as the availability of the capabilities in network devices 110.

In other words, scheduler 126 can select network devices 110 with capabilities that best match the capabilities needed to perform tasks 128. The scheduling by scheduler 126 is performed in a manner that increases the ability to meet a desired quality of service (QoS) for user 124.

Further, scheduler 126 may operate to schedule tasks 128 for other users in addition to or in place of user 124. This scheduling may be performed using network devices 110 for multiple users. As a result, the ability to distribute workloads is increased with additional network devices and users.

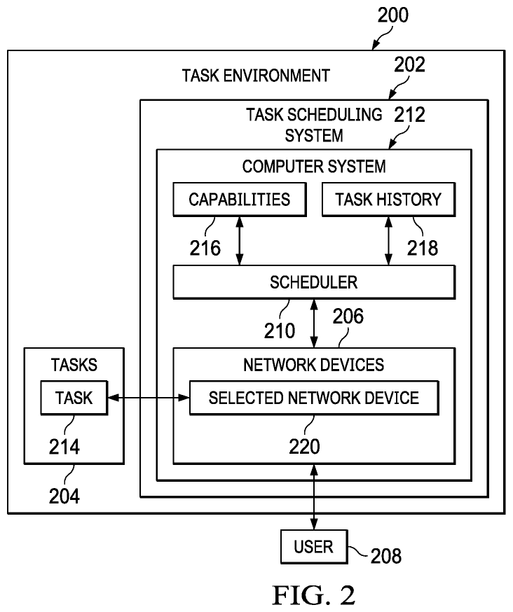

With reference now to FIG. 2, a block diagram of a task environment is depicted in accordance with an illustrative embodiment. In this illustrative example, task environment 200 includes components that can be implemented in hardware, such as the hardware shown in network data processing system 100 in FIG. 1.

In this illustrative example, task scheduling system 202 in task environment 200 operates to manage the performance of tasks 204. In this example, tasks 204 are performed by network devices 206 for user 208. In this example, network devices 206 can be selected from at least one of a network device associated with user 208, another network device associated with another user, an Internet of Things device, an automobile, a mobile phone, a tablet computer, a game console, a set top box, a thermostat, a refrigerator, a switch, a sensor, a camera, an actuator, a television, a security system, or some other suitable type of network device.

As depicted, task scheduling system 202 comprises scheduler 210 in computer system 212. Scheduler 126 in FIG. 1 is an example of one implementation of scheduler 210 in FIG. 2.

Computer system 212 is a physical hardware system and includes one or more data processing systems. When more than one data processing system is present, those data processing systems are in communication with each other using a communications medium. The communications medium may be a network. The data processing systems may be selected from at least one of a computer, a server computer, a tablet computer, or some other suitable data processing system.

In this illustrative example, scheduler 210 runs on computer system 212. During operation, scheduler 210 receives task 214 to process for user 208. Scheduler 210 identifies a group of network devices 206 in computer system 212 assigned to user 208 for processing task 214 based on capabilities 216 of the group of network devices 206 and task history 218 of task processing by the group of network devices 206. Scheduler 210 schedules the performance of task 214 by selected network device 220 in the group of network devices 206. As a result, task 214 is performed by selected network device 220 in computer system 212 such that tasks 204 are processed by sharing workloads among network devices 206.

Scheduler 210 may be implemented in software, hardware, firmware, or a combination thereof. When software is used, the operations performed by scheduler 210 may be implemented in program code configured to run on hardware, such as a processor unit. When firmware is used, the operations performed by scheduler 210 may be implemented in program code and data stored in persistent memory to run on a processor unit. When hardware is employed, the hardware may include circuits that operate to perform the operations in scheduler 210.

In the illustrative examples, the hardware may take a form selected from at least one of a circuit system, an integrated circuit, an application specific integrated circuit (ASIC), a programmable logic device, or some other suitable type of hardware configured to perform a number of operations. With a programmable logic device, the device may be configured to perform the number of operations. The device may be reconfigured at a later time or may be permanently configured to perform the number of operations. Programmable logic devices include, for example, a programmable logic array, a programmable array logic, a field programmable logic array, a field programmable gate array, and other suitable hardware devices. Additionally, the processes may be implemented in organic components integrated with inorganic components and may be comprised entirely of organic components excluding a human being. For example, the processes may be implemented as circuits in organic semi conductors.

In one illustrative example, one or more technical solutions are present that overcome a technical problem with processing tasks with a network device that may have a limited capability with respect to the tasks assigned to the network device. As a result, one or more technical solutions may provide a technical effect of performing tasks in network devices having capabilities suited to perform particular types of tasks. Further, the technical solutions also provide a technical effect of utilizing capabilities in network devices that are currently idle or predicted to be idle when a task is to be performed.

As a result, computer system 212 operates as a special purpose computer system in which scheduler 210 in computer system 212 enables assigning tasks 204 to network devices 206 in a manner that allows for matching up tasks 204 with network devices 206 in a manner that increases efficiency in performing tasks 204. In other words, tasks 204 are scheduled to be performed by network devices 206 that have capabilities 216 that are best suited for performing tasks 204. For example, in one or more technical solutions a technical effect of having a network device with the best capability to process a task is present. In particular, scheduler 210 transforms computer system 212 into a special purpose computer system as compared to currently available general computer systems that do not have scheduler 210.

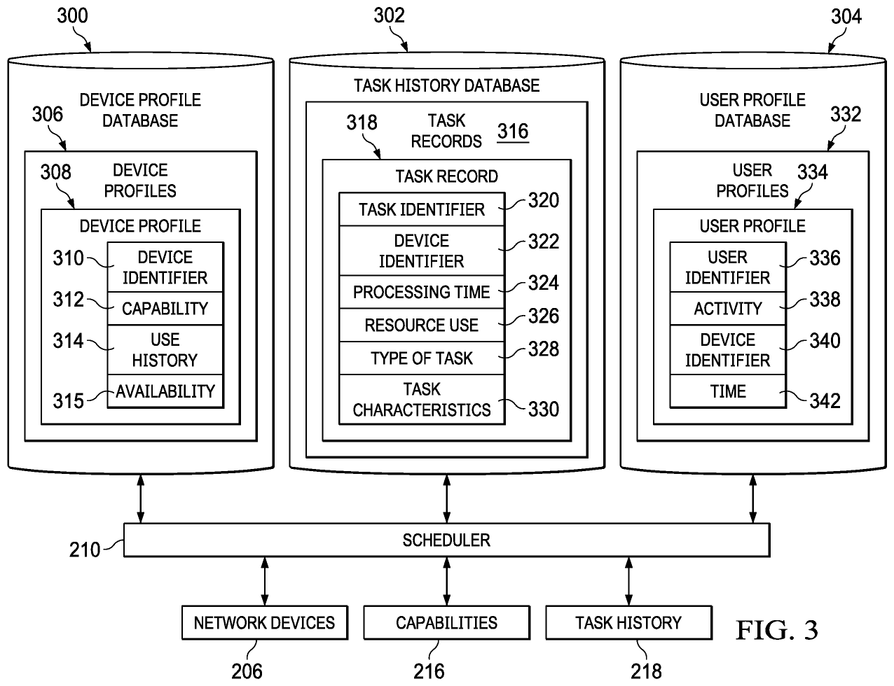

With reference to FIG. 3, an illustration of network device identification is depicted in accordance with an illustrative embodiment. In the illustrative examples, the same reference numeral may be used in more than one figure. This reuse of a reference numeral in different figures represents the same element in the different figures.

In this illustrative example, scheduler 210 uses at least one of device profile database 300, task history database 302, or user profile database 304 to identify a set of network devices 206 used to perform task 214.

In this illustrative example, device profile database 300 contains device profiles 306 for network devices 206. Device profile 308 is an example of one manner in which device profiles 306 can be implemented. In this illustrative example, device profile 308 includes device identifier 310, capability 312, use history 314, and availability 315.

Device identifier 310 identifies a network device in network devices 206. Device identifier 310 may take a number of different forms. For example, device identifier 310 may comprise at least one of a serial number, a model number, a device name, a media access control (MAC) address, or some other suitable identifier that can be used to uniquely identify a network device within network devices 206.

Capability 312 identifies a group of capabilities for the network device. For example, capability 312 identifies capabilities for the network device selected from at least one of image processing, video processing, audio processing, sensor, voice to text conversion, text to voice conversion, communications, data storage, or some other suitable capability.

As depicted, use history 314 identifies a history of the use of a network device over time. Use history 314 can identify when the network device was used, capabilities used, and other performance use or metrics describing the use of the network device. This information can be used to predict when the network device may be available.

In this illustrative example, availability 315 can be used to indicate the current availability of a network device. The current availability of the network device can be identified from information received from the network device. Availability 315 also can be used to indicate when a network device may be available at some future point in time. For example, a pattern of use of the network device can be used to indicate when the network device is available for other tasks.

As depicted, task history database 302 stores a history of task performance for tasks 204 performed by network devices 206 in task records 316. In this example, task record 318 includes task identifier 320, device identifier 322, processing time 324, resource use 326, type of task 328, and task characteristics 330.

Task identifier 320 uniquely identifies task record 318 for a particular task performed. Device identifier 322 identifies a network device. Processing time 324 indicates the amount of time needed to perform the task. Resource use 326 identifies resources used to perform a task. These resources can be identified as capabilities of the network device. For example, resource use 326 may be, for example, graphics processing or image processing.

Type of task 328 identifies the type of task performed by the network device. For example, type of task 328 may be facial recognition or object recognition. Task characteristics 330 identify details about type of task 328 employed to perform the task. For example, if type of task 328 is object recognition, task characteristics 330 can use algorithms that perform landmark or feature identification, image matching, dividing, researching, interpretation trees, or other types of algorithms that can be used to recognize objects.

In this illustrative example, user profile database 304 contains user profiles 332 providing information about users. For example, user profile 334 in user profiles 332 comprises user identifier 336, activity 338, device identifier 340, and time 342.

User identifier 336 identifies the user. User identifier 336 can be, for example, at least one of the name of the user, the user ID number, or some other suitable type of identifier. Activity 338 identifies an activity for the user interacting with a network device. For example, the activity may be playing a video game. Device identifier 340 identifies the network device that the user is utilizing for the activity. For example, device identifier 340 may be a model and a serial number for a game console.

Time 342 identifies the time of day and the date when the activity occurred. Time 342 also includes how much time a network device was used for the activity. In this illustrative example, user profile 334 may include multiple fields for activity 338, device identifier 340, and time 342.

The information in user profile 334 is used to identify the use of devices assigned to the user over time. This information can be used to predict when a network device has a capability that is available for use in processing a task.

In this illustrative example, scheduler 210 identifies capabilities 216 and task history 218 for network devices 206 using information in at least one of device profile database 300, task history database 302, and user profile database 304. Additionally, scheduler 210 can predict an availability of network devices 206 using these databases.

With access to at least one of device profile database 300, task history database 302, or user profile database 304, scheduler 210 identifies a group of network devices from network devices 206 for processing a task based on capabilities 216 of the group of network devices 206 and based on task history 218 of task processing by the group of network devices 206. The group of network devices 206 can be also be selected using user profile 334 in which a history of user interaction with the group of network devices 206 is identified. Further, the selection of the group of network devices 206 can be made using an availability of network devices with a capability used to perform the task. The availability can be a predicted availability of network devices 206 based on the history of interaction between user 208 and network devices 206. In other illustrative examples, the availability of network devices 206 can be obtained from network devices 206 and stored in device profiles 306, such as in availability 315 in device profiles 306.

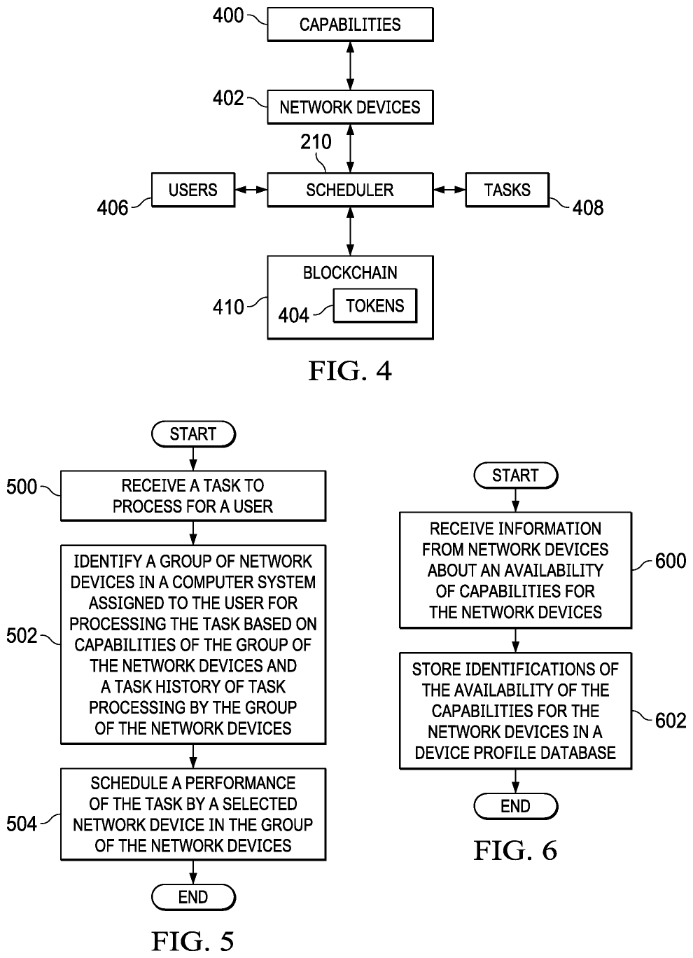

With reference now to FIG. 4, a block diagram illustrating managing resources using tokens is depicted in accordance with an illustrative embodiment. In this illustrative example, scheduler 210 manages the use of capabilities 400 for network devices 402 through tokens 404. Tokens 404 may take a number of different forms. For example, tokens 404 are representations of the value of capabilities 400 of network devices 402 used to perform tasks 408.

In this illustrative example, tokens 404 can be selected from at least one of a crypto currency, IOTA currency, or other types of items that can be traded. Tokens 404 may also represent physical items in some illustrative examples. Tokens 404 can be tracked using blockchain 410. Blockchain 410 is a list of records which are linked and secured using cryptography. In this illustrative example, tokens 404 can be assigned to or associated with at least one of users 406 or network devices 402 using blockchain 410. As depicted, blockchain 410 can function as a distributed ledger to track ownership of tokens 404.

In this example, scheduler 210 can reallocate tokens 404 between at least one of users 406 or network devices 402 when scheduling tasks 408 for performance by network devices 402. For example, a first user in users 406 may agree to trade a number of tokens 404 in exchange for a game console in network devices 402 having an image processing capability to perform an object recognition task. In other illustrative examples, the exchange of tokens 404 may be made between network devices 402 without interaction from users 406.

The number of tokens 404 requested, offered, or traded can depend on the value of the capability. The value can be based on at least one of how available the capability is in network devices 402, the time when the capability is needed, the demand for the capability from users 406, or other factors. Thus, scheduler 210 can facilitate the trading of tokens 404 based on using capabilities 400 of network devices 402 in response to performing tasks 408.

The illustration of task environment 200 and the different components illustrated in FIGS. 2-4 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

The illustration of the different databases used by scheduler 210 in FIG. 2 is not meant to limit the manner in which information may be stored or the type of information that is used by scheduler 210 to identify the group of network devices 206 to perform tasks 204. For example, capabilities 216 are described as services that can be provided by network devices 206.

In other illustrative examples, capabilities 216 may describe at least one of hardware or software available in network devices 206. For example, capabilities 216 may include at least one of a central processing unit, a graphics processing unit, a random-access memory, a solid-state disk drive, a temperature sensor, a global positioning system receiver, an accelerometer, a camera, or other suitable components. In still other illustrative examples, capabilities 216 may describe both services and hardware or software available in network devices 206.

Turning next to FIG. 5, a flowchart of a process for managing processing of tasks is depicted in accordance with an illustrative embodiment. The process in FIG. 5 can be implemented in hardware, software, or both. When implemented in software, the process can take the form of program code that is run by one of more processor units located in one or more hardware devices in one or more computer systems. For example, the process can be implemented in scheduler 210 running on computer system 212 in FIG. 2.

The process begins by receiving a task to process for a user (step 500). The process identifies a group of network devices in a computer system assigned to the user for processing the task based on capabilities of the group of the network devices and a task history of task processing by the group of the network devices (step 502).

The process schedules a performance of the task by a selected network device in the group of the network devices (step 504). The process terminates thereafter. In step 504, the network device can be scheduled by sending the task to the network device if the task is scheduled to be performed immediately. Otherwise, the task can be sent to the network device at the time when the task is to be performed. In another illustrative example, the task can be sent to the network device with a schedule as to when the task should be performed.

The task is performed by the selected network device in the computer system such that tasks are processed by sharing workloads among the network devices. The manner in which tasks are assigned in this process take into account the capabilities of the network device. By taking into account the task history of task processing by network devices, this process also takes into account the amount of time needed to process a task. In this manner, the scheduling of tasks can be performed in a manner that increases the speed at which tasks can be completed. For example, if an image processing task takes 10 minutes to process based on the task history, and a network device with image processing capabilities is idle and is expected to be idle for at least the next 10 minutes, that network device can be scheduled to handle the image processing task. The availability of the network device can be identified using a device profile in a device profile database for the network device.

With reference next to FIG. 6, a flowchart of a process for identifying an availability of network devices is depicted in accordance with an illustrative embodiment. The process in FIG. 6 can be implemented in hardware, software, or both. When implemented in software, the process can take the form of program code that is run by one of more processor units located in one or more hardware devices in one or more computer systems. For example, the process can be implemented in scheduler 210 running on computer system 212 in FIG. 2.

The process begins by receiving information from network devices about an availability of capabilities for the network devices (step 600). In step 600, the network devices can externalize the capabilities and the availability of the capabilities. For example, a network device can broadcast capabilities and availability information. In other examples, the network device can register with the scheduler and periodically send information about the capabilities and the availability of the capabilities of the network device. In this manner, actual availability can be identified for tasks that should be performed currently or in the near future. For tasks to be performed in a future time, the availability can be predicted based on the use of the network devices assigned to the user over time stored in a user profile database.

The process stores identifications of the availability of the capabilities for the network devices in a device profile database (step 602). The process terminates thereafter.

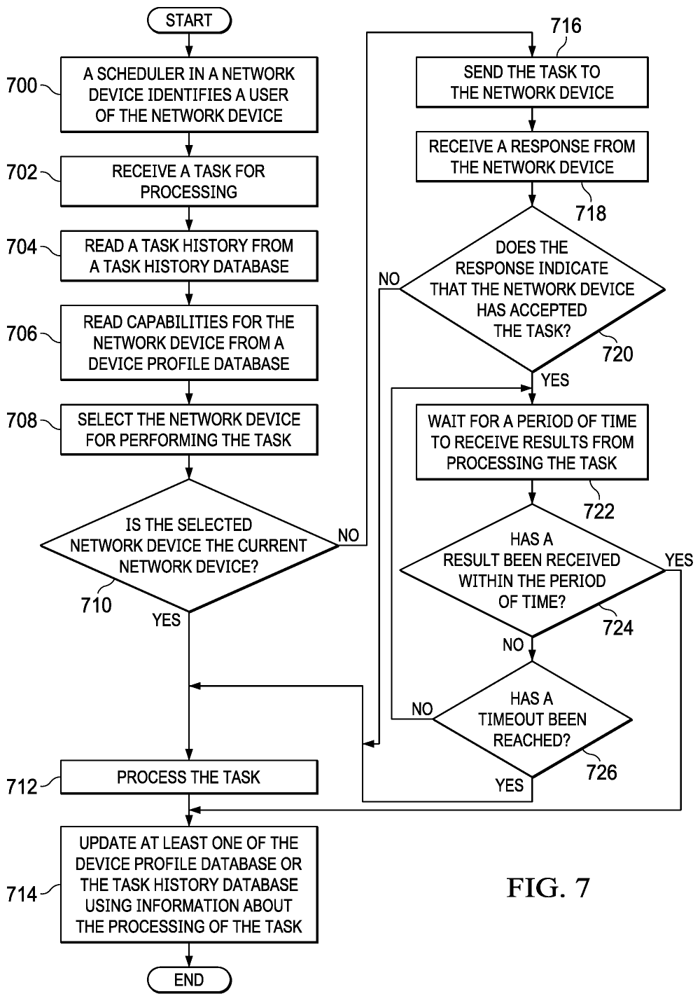

Turning next to FIG. 7, a flowchart of a process for scheduling a task is depicted in accordance with an illustrative embodiment. The process in FIG. 7 can be implemented in hardware, software, or both. When implemented in software, the process can take the form of program code that is run by one of more processor units located in one or more hardware devices in one or more computer systems.

The process illustrated in FIG. 7 can be implemented in a scheduler located in a network device. For example, the process can be implemented in scheduler 210 located in a network device in network devices 206 in FIG. 2.

The process begins with a scheduler in a network device identifying a user of the network device (step 700). The user can be identified by logging in to use the network device.

The process then receives a task for processing (step 702). The task may be received in a request, a register, or in some other manner. The task includes a task identifier, parameters for the task, a type of task, capabilities desired for performing the task, and a user identifier identifying the user for which the task is performed.

The process reads a task history from a task history database (step 704). The task history may be the task history found in task history database 302 in FIG. 3 containing task records identifying the performance of similar tasks to the task received in step 702. The identification of the similar tasks may be based on the type of task identified for the task received in step 702.

The process reads capabilities for the network device from a device profile database (step 706). In step 706, the device profile database may be, for example, device profile database 300 in FIG. 3. Information may be used to identify the capabilities for network devices that can potentially be used to perform the received task.

The process selects the network device for performing the task (step 708). In step 708, the process may identify a group of network devices that are capable of performing the task. For example, if the task is an image processing task, then the group of the network devices can be selected from those that have image processing capabilities. These network devices may be, for example, devices that have graphic processing units.

If more than one network device is identified for the group of the network devices that provide the capability to perform the task, the best network device can be selected from the group. The best network device may be selected based on a number of different factors. For example, the best network device may be selected based on at least one of token cost, a deadline for processing the task, when processing the task is to begin, whether a network device is currently being used for another task, or other factors.

The process determines whether the selected network device is the current network device (step 710). In step 710, the current network device is the network device that is running a scheduler. If the selected network device is the current network device, the process processes the task (step 712).

The process then updates at least one of the device profile database or the task history database using information about the processing of the task (step 714). The process terminates thereafter. In step 714, the device profile database can be updated with a use history based on the current processing task. As another example, the task history database can be updated with information about the network device processing the task, the processing time, resource use, the type of task, and task characteristics.

With reference again to step 710, if the selected device is not the current device, the process sends the task to the network device (step 716). In step 716, the task can be sent to the network device with a schedule as to when the task should be performed to schedule performance of the task by the network device.

In step 716, the task can be sent in a request to the selected network device. In this example, the request includes a requestor identifier, a task identifier, a capability identifier, and task information. The requestor identifier identifies the network device or other device on which the scheduler is located. The task identifier identifies the task being requested. The capability identifier identifies the capability needed for the task. The task information includes data, parameters, and the type of task that is to be processed.

The process receives a response from the network device (step 718). A determination is made as to whether the response indicates that the network device has accepted the task (step 720). If the task has been accepted by the network device, the process waits for a period of time to receive results from processing the task (step 722).

After the period of time has passed, a determination is made as to whether a result has been received within the period of time (step 724). If a result has not been received, a determination is made as to whether a timeout has been reached (step 726). If a timeout has not been reached, the process returns to step 722. The timeout can be set in a number of different ways. For example, the timeout can be set for a period of time after which a result is not expected from the selected device or if the result will not be received within a desired amount of time.

With reference again to step 724, if a result has been received within the period of time, the process returns to step 714. Turning back to step 726, if a timeout has been reached, the process returns to step 712. In this case, the process is performed by the current network device as a result of the selected network device not returning results by the timeout. With reference again to step 720, if the response indicates that the network device has not accepted the task, the process returns to step 712 to process the task.

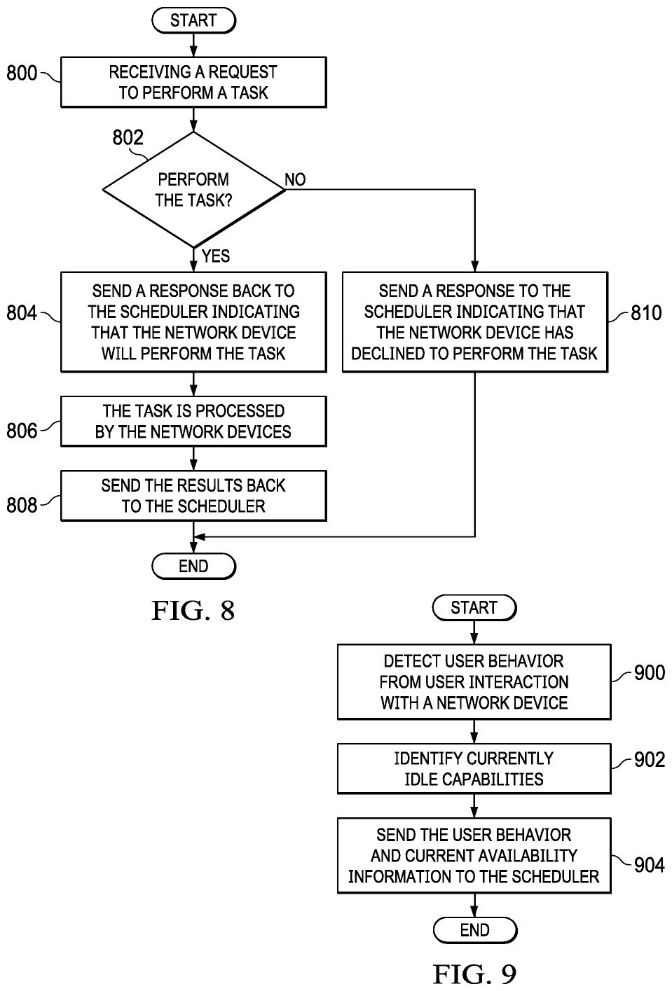

Turning next to FIG. 8, a flowchart of a process for processing a request to perform a task is depicted in accordance with an illustrative embodiment. The process illustrated in FIG. 8 can be implemented in hardware, software, or both. When implemented in software, the processes can take the form of program code that is run by one of more processor units located in one or more hardware devices in one or more computer systems. For example, these processes can be implemented in a network device in network devices 206 in computer system 212 in FIG. 2.

The process begins by receiving a request to perform a task (step 800). The request is received from a scheduler on another network device.

The process determines whether to perform the task (step 802). The determination can be based on a number of different factors. For example, the process can determine whether a capability needed to process the task is available. As another example, the process can determine whether sufficient power is present to perform the task if the network device is operating on battery power. A selected level of battery power may need to be available to perform other tasks. As another example, the process can determine whether a token transaction is completed.

If a determination is made to perform the task, the process sends a response back to the scheduler indicating that the network device will perform the task (step 804). The task is processed by the network device (step 806). The process sends the results back to the scheduler (step 808). The process terminates thereafter. With reference again to step 802, if a determination is made not to perform the task, a response is sent to the scheduler indicating that the network device has declined to perform the task (step 810). The process terminates thereafter.

With reference next to FIG. 9, a flowchart of a process for indicating an availability is depicted in accordance with an illustrative embodiment. The process illustrated in FIG. 9 can be implemented in hardware, software, or both. When implemented in software, the process can take the form of program code that is run by one of more processor units located in one or more hardware devices in one or more computer systems. For example, the process can be implemented in a network device in network devices 206 in computer system 212 in FIG. 2.

The process beings by detecting user behavior from user interaction with a network device (step 900). The behavior of the user can be used to identify what capabilities are used and when those capabilities are typically used. This information can be used to predict an availability of the capabilities in the network device.

The process identifies currently idle capabilities (step 902). This step identifies the current availability of the capabilities in the network device.

The process sends user behavior and current availability information to the scheduler (step 904). The process terminates thereafter. In step 904, the network device externalizes the current capabilities that can used to process tasks. This process can be repeated periodically or in response to an event, such as powering up the network device.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks may be implemented as program code, hardware, or a combination of program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or a block diagram.

For example, step 806 can be performed at the same time as step 804 or before step 804 in the flowchart in FIG. 8. In another example, step 900 in FIG. 9 can be omitted.

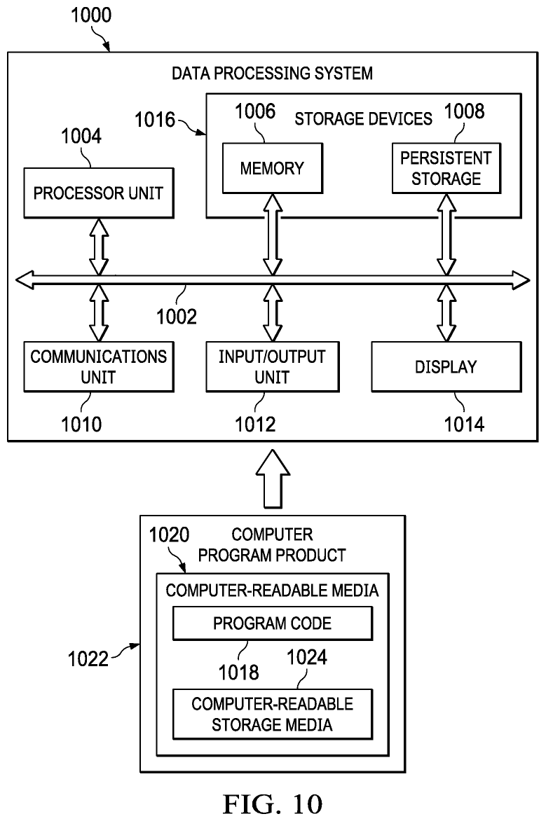

Turning now to FIG. 10, a block diagram of a data processing system is depicted in accordance with an illustrative embodiment. Data processing system 1000 may be used to implement server computer 104, server computer 106, and network devices 110 in FIG. 1. Data processing system 1000 can also be used to implement one or more data processing systems in computer system 212 in FIG. 2. In this illustrative example, data processing system 1000 includes communications framework 1002, which provides communications between processor unit 1004, memory 1006, persistent storage 1008, communications unit 1010, input/output unit 1012, and display 1014. In this example, communications framework 1002 may take the form of a bus system.

Processor unit 1004 serves to execute instructions for software that may be loaded into memory 1006. Processor unit 1004 may be a number of processors, a multi-processor core, or some other type of processor, depending on the particular implementation.

Memory 1006 and persistent storage 1008 are examples of storage devices 1016. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1016 may also be referred to as computer-readable storage devices in these illustrative examples. Memory 1006, in these examples, may be, for example, a random-access memory or any other suitable volatile or non-volatile storage device. Persistent storage 1008 may take various forms, depending on the particular implementation.

For example, persistent storage 1008 may contain one or more components or devices. For example, persistent storage 1008 may be a hard drive, a solid-state drive (SSD), a flash memory, a rewritable optical disk, a rewritable magnetic tape, or some combination of the above. The media used by persistent storage 1008 also may be removable. For example, a removable hard drive may be used for persistent storage 1008.

Communications unit 1010, in these illustrative examples, provides for communications with other data processing systems or devices. In these illustrative examples, communications unit 1010 is a network interface card.

Input/output unit 1012 allows for input and output of data with other devices that may be connected to data processing system 1000. For example, input/output unit 1012 may provide a connection for user input through at least one of a keyboard, a mouse, or some other suitable input device. Further, input/output unit 1012 may send output to a printer. Display 1014 provides a mechanism to display information to a user.

Instructions for at least one of the operating system, applications, or programs may be located in storage devices 1016, which are in communication with processor unit 1004 through communications framework 1002. The processes of the different embodiments may be performed by processor unit 1004 using computer-implemented instructions, which may be located in a memory, such as memory 1006.

These instructions are referred to as program code, computer usable program code, or computer-readable program code that may be read and executed by a processor in processor unit 1004. The program code in the different embodiments may be embodied on different physical or computer-readable storage media, such as memory 1006 or persistent storage 1008.

Program code 1018 is located in a functional form on computer-readable media 1020 that is selectively removable and may be loaded onto or transferred to data processing system 1000 for execution by processor unit 1004. Program code 1018 and computer-readable media 1020 form computer program product 1022 in these illustrative examples. In the illustrative example, computer-readable media 1020 is computer-readable storage media 1024.

In these illustrative examples, computer-readable storage media 1024 is a physical or tangible storage device used to store program code 1018 rather than a medium that propagates or transmits program code 1018.

Alternatively, program code 1018 may be transferred to data processing system 1000 using a computer-readable signal media. The computer-readable signal media may be, for example, a propagated data signal containing program code 1018. For example, the computer-readable signal media may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 1000 are not meant to provide architectural limitations to the manner in which different embodiments may be implemented. The different illustrative embodiments may be implemented in a data processing system including components in addition to or in place of those illustrated for data processing system 1000. Other components shown in FIG. 10 can be varied from the illustrative examples shown. The different embodiments may be implemented using any hardware device or system capable of running program code 1018.

Thus, the illustrative embodiments provide a method, an apparatus, a computer system and a computer program product for managing processing of tasks. In one illustrative example, a method for managing the processing of the tasks by network devices includes receiving, by a computer system, a task to process for a user. The computer system identifies a group of the network devices in the computer system assigned to the user for processing the task based on capabilities of the group of the network devices and a task history of task processing by the group of the network devices. The computer system schedules a performance of the task by a selected network device in the group of the network devices. The task is performed by the selected network device in the computer system such that the tasks are processed by sharing workloads among the network devices.

In one illustrative example, one or more technical solutions are present that overcome a technical problem with processing tasks with a network device that may have limited capability with respect to the tasks assigned to the network device. As a result, one or more technical solutions in one or more examples provide a technical effect of performing tasks using network devices having capabilities suited to perform particular types of tasks. Further, the technical solutions also provide a technical effect of utilizing capabilities in network devices that are currently idle or predicted to be idle when a task is to be performed.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A method for managing processing of tasks by network devices, the method comprising:
receiving, by a computer system, a task to process for a user;
identifying, by the computer system, a group of the network devices in the computer system assigned to the user for processing the task based on capabilities of the group of the network devices and a task history of task processing by the group of the network devices; and
scheduling, by the computer system, a performance of the task by a selected network device in the group of the network devices, wherein the task is performed by the selected network device in the computer system such that the tasks are processed by sharing workloads among the network devices.

2. The method of claim 1, wherein identifying, by the computer system, the group of the network devices in the computer system assigned to the user for processing the task based on the capabilities of the group of the network devices and the task history of task processing by the group of the network devices comprises:
identifying, by the computer system, the group of the network devices in the computer system assigned to the user for processing the task based on the capabilities of the group of the network devices, the task history of task processing by the group of the network devices, and a user profile identifying a history of user interaction with the group of the network devices.

3. The method of claim 1, wherein identifying, by the computer system, the group of the network devices in the computer system assigned to the user for processing the task based on the capabilities of the group of the network devices and the task history of task processing by the group of the network devices comprises:
identifying, by the computer system, the group of the network devices in the computer system assigned to the user for processing the task based on the capabilities of the group of the network devices, the task history of task processing by the group of the network devices, and an availability of the network devices with a capability used to perform the task.

4. The method of claim 3, wherein the task history of task processing comprises a database of task records, wherein a task record in the task records comprises a device identifier, a processing time, a resource use, a type of task, and task characteristics.

5. The method of claim 3, wherein the capabilities of the group of the network devices are identified in a device profile database.

6. The method of claim 1 further comprising:
trading tokens based on using the capabilities of the network devices in response to performing the tasks.

7. The method of claim 1 further comprising:
receiving information from the network devices about an availability of the capabilities for the network devices; and
storing identifications of the availability of the capabilities for the network devices in a device profile database.

8. The method of claim 1, wherein the capabilities of the group of the network devices comprise at least one of image processing, video processing, audio processing, sensor, communications, voice to text conversion, text to voice conversion, or data storage.

9. The method of claim 1, wherein the group of the network devices is selected from at least one of a network device associated with the user, another network device associated with another user, an Internet of Things device, an automobile, a mobile phone, a tablet computer, a game console, a set top box, a thermostat, a refrigerator, a switch, a sensor, a camera, an actuator, a television, or a security system and wherein the group of the network devices are in a network selected from at least one of an Internet, an intranet, a local area network, a metropolitan area network, or a wide area network.

10. A task processing system comprising:
a computer system; and
a scheduler running on the computer system, wherein the scheduler receives a task to process for a user; identifies a group of network devices in the computer system assigned to the user for processing the task based on capabilities of the group of the network devices and a task history of task processing by the group of the network devices; and schedules a performance of the task by a selected network device in the group of the network devices, wherein the task is performed by the selected network device in the computer system such that tasks are processed by sharing workloads among the network devices.

11. The task processing system of claim 10, wherein in identifying the group of the network devices in the computer system assigned to the user for processing the task based on the capabilities of the group of the network devices and the task history of task processing by the group of the network devices, the scheduler identifies the group of the network devices in the computer system assigned to the user for processing the task based on the capabilities of the group of the network devices; the task history of task processing by the group of the network devices; and a user profile identifying a history of user interaction with the group of the network devices.

12. The task processing system of claim 10, wherein in identifying the group of the network devices in the computer system assigned to the user for processing the task based on the capabilities of the group of the network devices and the task history of task processing by the group of the network devices, the scheduler identifies the group of the network devices in the computer system assigned to the user for processing the task based on the capabilities of the group of the network devices; the task history of task processing by the group of the network devices; and an availability of the network devices with a capability used to perform the task.

13. The task processing system of claim 12, wherein the task history of task processing comprises a database of task records, wherein a task record in the task records comprises a device identifier, a processing time, a resource user, a type of task, and task characteristics.

14. The task processing system of claim 12, wherein the capabilities of the group of the network devices are identified in a device profile database.

15. The task processing system of claim 10, wherein the scheduler trades tokens based on the capabilities of the network devices in response to performing the tasks.

16. The task processing system of claim 10, wherein the scheduler receives information from the network devices about an availability of the capabilities for the network devices and stores identifications of the availability of the capabilities for the network devices in a device profile database.

17. The task processing system of claim 10, wherein the group of the network devices is selected from at least one of a network device associated with the user, another network device associated with another user, an Internet of Things device, an automobile, a mobile phone, a tablet computer, a game console, a set top box, a thermostat, a refrigerator, a switch, a sensor, a camera, an actuator, a television, or a security system and wherein the network devices are in a network selected from at least one of an Internet, an intranet, a local area network, a metropolitan area network, or a wide area network.

18. A computer program product for managing processing of tasks by network devices, the computer program product comprising:
a computer-readable storage media;
first program code, stored on the computer-readable storage media, for receiving a task to process for a user;
second program code, stored on the computer-readable storage media, for identifying a group of the network devices in a computer system assigned to the user for processing the task based on capabilities of the group of the network devices and a task history of task processing by the group of the network devices; and
third program code, stored on the computer-readable storage media, for scheduling a performance of the task by a selected network device in the group of the network devices, wherein the task is performed by the selected network device in the computer system such that the tasks are processed by sharing workloads among the network devices.

19. The computer program product of claim 18, wherein the third program code comprises:
program code, stored on the computer-readable storage media, for identifying the group of the network devices in the computer system assigned to the user for processing the task based on the capabilities of the group of the network devices; the task history of task processing by the group of the network devices; and a user profile identifying a history of user interaction with the group of the network devices.

20. The computer program product of claim 18, wherein the third program code comprises:
program code, stored on the computer-readable storage media, for identifying the group of the network devices in the computer system assigned to the user for processing the task based on the capabilities of the group of the network devices; the task history of task processing by the group of the network devices; and an availability of the network devices with a capability used to perform the task.
